(19) United States
(12) Patent Application Publication
(10) Pub. No.: US 2023/0305810 A1
(43) Pub. Date: Sep. 28, 2023

(54) RANDOM NUMBER GENERATION CIRCUIT

(71) Applicants: Kabushiki Kaisha Toshiba, Tokyo (JP); Toshiba Electronic Devices & Storage Corporation, Tokyo (JP)

(72) Inventors: Hiroo NAKANO, Chigasaki Kanagawa (JP); Mdbelayet ALI, Kawasaki Kanagawa (JP)

(21) Appl. No.: 17/901,960

(22) Filed: Sep. 2, 2022

(30) Foreign Application Priority Data
Mar. 25, 2022 (JP) 2022-050403

(51) Int. Cl. G06F 7/58

(52) U.S. Cl. CPC G06F 7/588

(57) ABSTRACT

A random number generation circuit in an embodiment includes a sampling circuit configured to capture an oscillation output of a ring oscillator using a first clock and generate a random number value, a periodicity detection circuit configured to detect periodicity of an output of the sampling circuit, a randomness test circuit configured to perform a randomness test for the output of the sampling circuit, and a control circuit configured to change an oscillation period of the oscillation output based on a detection result of the periodicity detection circuit, divide a random number output based on the random number value into a plurality of divided random numbers to perform random number generation for each of the divided random numbers, and cause the randomness test circuit to execute the randomness test for each generation of the divided random numbers.

### CROSS REFERENCE TO RELATED APPLICATION

This application is based upon and claims the benefit of priority from the prior Japanese Patent Application No. 2022-050403 filed in Japan on Mar. 25, 2022, the entire contents of which are incorporated herein by reference.

### FIELD

An embodiment described herein relates generally to a random number generation circuit.

### BACKGROUND

Requests for information security have been increasing along with the development of information communication technology. Random numbers are used in key generation, authentication, and the like, which are indispensable for information security technology. The quality of the random numbers is extremely important in security. In general, in a random number generator configured by a digital circuit, a ring oscillator (hereinafter referred to as RO as well) is often used as a noise source. The RO as a generation source of high-entropy data is required to have high reliability.

### BRIEF DESCRIPTION OF THE DRAWINGS

FIG. 1 is a block diagram showing a random number generation circuit according to an embodiment of the present invention;

FIG. 2 is a circuit diagram showing an example of a specific configuration of an FF with enable 42 shown in FIG. 1;

FIG. 3 is a circuit diagram showing an example of a specific configuration of the FF with enable 42 shown in FIG. 1;

FIG. 4 is a circuit diagram showing an example of a specific configuration of an oscillation frequency variable RO 21;

FIG. 5 is a circuit diagram showing an example of a circuit configuration of a periodicity detection circuit 25 and a randomness test circuit 26;

FIG. 6 is a circuit diagram showing an example of a circuit configuration of the randomness test circuit 26;

FIG. 7 is a circuit diagram showing an example of a circuit configuration of a part of the periodicity detection circuit 25 and the randomness test circuit 26;

FIG. 8 is a circuit diagram showing an example of a circuit configuration of a part of the periodicity detection circuit 25 and the randomness test circuit 26;

FIG. 9 is a flowchart for explaining an operation in the embodiment;

FIG. 10 is a timing chart showing operation timing in the embodiment;

FIG. 11 is a timing chart at a periodicity detection time;

FIG. 12 is a timing chart at a randomness test time;

FIG. 13 is a timing chart for explaining an enable signal SHIFTENy_p3 supplied to a shift register group 40;

FIG. 14 is a timing chart showing a specific example of an operation in the embodiment; and

FIG. 15 is a timing chart showing a specific example of an operation in the embodiment.

### DETAILED DESCRIPTION

A random number generation circuit in an embodiment includes: a sampling circuit configured to capture an oscillation output of a ring oscillator using a first clock and generate a random number value; a periodicity detection circuit configured to detect periodicity of an output of the sampling circuit; a randomness test circuit configured to perform a randomness test for the output of the sampling circuit; and a control circuit configured to change an oscillation period of the oscillation output based on a detection result of the periodicity detection circuit, divide a random number output based on the random number value into a plurality of divided random numbers to perform random number generation for each of the divided random numbers, and cause the randomness test circuit to execute the randomness test for each generation of the divided random numbers.

An embodiment of the present invention is explained in detail below with reference to the drawings.

### Embodiment

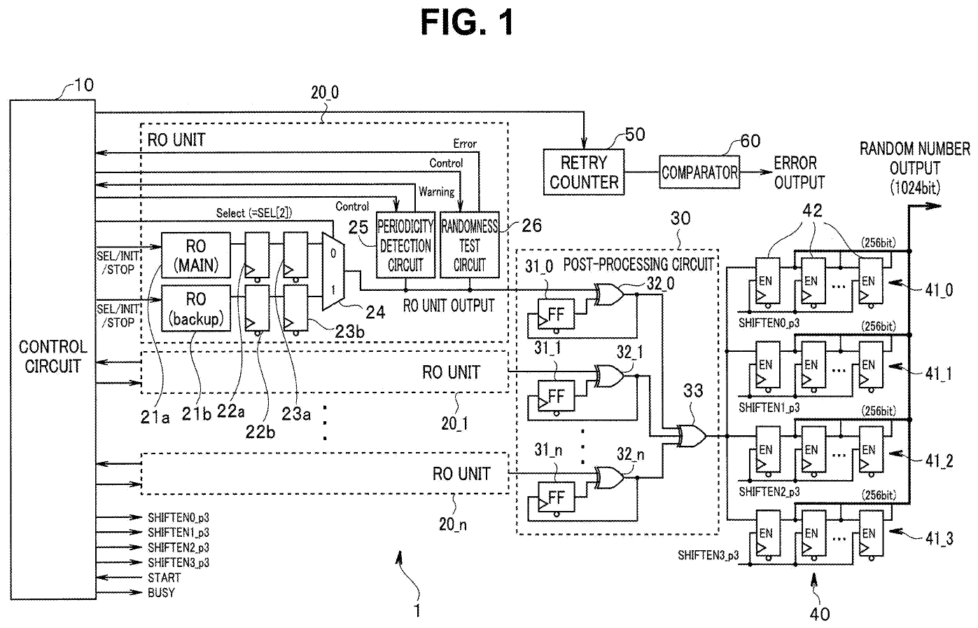

FIG. 1 is a block diagram showing a random number generation circuit according to an embodiment of the present invention. In the present embodiment, a randomness test circuit is provided in a ring oscillator (RO) unit including ROs, a random number having a predetermined number of bits is divided into a plurality of random numbers to generate random numbers which are divided (hereinafter referred to as divided random numbers), and a randomness test is carried out for each of the divided random numbers to reduce a drift amount of an oscillation period change of the ROs involved in heat generation of RO oscillation or the like and reduce the number of times of error occurrence of the randomness test and make it possible to stably obtain a high-entropy random number.

In FIG. 1, a random number generation circuit 1 includes a control circuit 10, a plurality of RO units 20_0, 20_1, . . . , and 20_n (hereinafter these RO units are representatively referred to as RO units 20), a post-processing circuit 30, a shift register group 40, a retry counter 50, and a comparator 60. The control circuit 10 controls operations of the RO units 20, the shift register group 40, and the retry counter 50. The random number generation circuit 1 is configured by logic circuits such as a NAND circuit, a NOR circuit, and a flip-flop circuit. In general, a function of the logic circuit is described as a source code in a hardware description language based on specifications of input and output signals and a flowchart and a timing chart. The logic circuit is realized by converting the source code into the logic circuit with a logic synthesizing tool. Note that the random number generation circuit 1 is given an instruction for random number generation by a not-shown higher system such as a host apparatus and generates a random number. A system clock CK and an asynchronous reset RESETN not shown in FIG. 1 are input to the random number generation circuit 1. The system clock CK is input to a clock of a flip-flop (hereinafter, FF) used in the random number generation circuit 1. The FF captures an input to the FF at a rising edge of the system clock CK and sets the input as an output of the FF. At the asynchronous reset RESETN=0, all FFs in the random number generation circuit 1 are initialized to 0.

The configurations of the RO units 20_0 to 20_n are the same. Each of the RO units 20 includes two ring oscillators (ROs) 21a and 21b. The ROs 21a and 21b have the same configuration and oscillate at a period depending on an operating temperature, a voltage, a circuit configuration, a wire length, manufacturing variation, and the like and alternately output a logical value “1” or “0”. Note that the RO 21a is a main oscillation circuit (main) and the RO 21b is a backup oscillation circuit (backup) of the RO 21a.

An oscillation output of the RO 21a is supplied to an FF 22a. The FF 22a captures the oscillation output of the RO 21a and outputs the oscillation output to an FF 23a in synchronization with the system clock CK (not shown) input to the random number generation circuit 1. The FF 23a captures the output of the FF 22a in synchronization with the system clock CK and outputs the output to an input end (0) of a selector 24 in synchronization with the system clock CK. An oscillation output of the RO 21b is supplied to an FF 22b. The FF 22b captures the oscillation output of the RO 21b and outputs the oscillation output to an FF 23b in synchronization with the system clock CK. The FF 23b captures the output of the FF 22b and outputs the output to an input end (1) of the selector 24 in synchronization with the system clock CK. The selector 24 is controlled by a selection signal (Select) received from the control circuit 10 to select the input end (0) or the input end (1) to output the output of the FF 23a or the output of the FF 23b.

The oscillation outputs of the ROs 21a and 21b (hereinafter, RO oscillation outputs) and the system clock CK are asynchronous. The FFs 22a and 22b (hereinafter, these FFs are representatively referred to as FFs 22) respectively sample the RO oscillation outputs with the system clock CK asynchronous with the RO oscillation outputs. When a period of the RO oscillation outputs (hereinafter, RO oscillation period) and a clock period of the system clock CK are nearly in a multiple relation, a phase relation between the RO oscillation outputs and the system clock CK less easily changes, values of the RO oscillation outputs captured at the rising edge of the system clock CK tend to be the same, and a fixed value tends to last as the outputs of the FFs 22. When the RO oscillation periods and the clock period of the system clock CK are just in the multiple relation, a fixed value lasts as the outputs of the FFs 22. When the system clock CK period is not a multiple of the RO oscillation period, the outputs of the FFs 22 are data having periodicity determined by a least common multiple of the system clock CK period and the RO oscillation period. Timing when the rising edge of the system clock CK and a rising edge or a falling edge of the RO oscillation outputs overlap sometimes appears. The outputs of the FFs 22 become irregular values because of a jitter (fluctuation) of the RO oscillation outputs or a metastable of the FFs 22. The irregular value leads to entropy and causes randomness.

Note that, when the metastable occurs in the FFs 22, the outputs of the FFs 22 are temporarily in an unstable state. By capturing outputs of the FF 22a and the FF 22b respectively with the FF 23a and the FF 23b in a second stage (hereinafter, these FFs are representatively referred to as FFs 23), decided data after the metastable settles can be obtained. In this way, a sampling circuit for the RO oscillation outputs is configured by the FFs 22 and 23. Irregular values are obtained from the FFs 23 because of the jitter of the RO oscillation outputs and the metastable of the FFs 22. This irregularity is entropy. As explained above, security strength in authentication or the like in which a random number is used can be further improved as the entropy is larger. Since the entropy obtained from the FFs 23 is small, accumulation of the entropy is performed by the post-processing circuit 30.

The selector 24 outputs, to the post-processing circuit 30, an output of the FF 23 selected based on the selection signal (Select) received from the control circuit 10. The post-processing circuit 30 accumulates entropy of the output (an RO unit output) of the selector 24 and increases entropy input to the shift register group 40.

The post-processing circuit 30 includes FFs 31_0, 31_1, . . . , and 31_n (hereafter, these FFs are representatively referred to as FFs 31) and exclusive OR circuits (hereinafter referred to as EXORs) 32_0, 32_1, . . . , and 32_n (hereinafter, these EXORs are representatively referred to as EXORs 32). Output data of the RO units 20_0, 20_1, . . . , and 20_n are respectively given to one input ends of the EXORs 32_0, 32_1, . . . , and 32_n. The FFs 31_0, 31_1, . . . , and 31_n are respectively input with outputs of the EXORs 32_0, 32_1, . . . , and 32_n, capture the input data in synchronization with the system clock CK, and respectively output the data to the other input ends of the RO units 20_0, 20_1, . . . , and 20_n.

The EXORs 32_0, 32_1, . . . , and 32_n perform an exclusive OR operation of the two inputs, output the inputs to the FFs 31_0, 31_1, . . . , and 31_n, and output the inputs to an EXOR 33 as well. The EXOR 33 is input with the outputs of the EXORs 32_0, 32_1, . . . , and 32_n, performs an exclusive OR operation of the inputs, and outputs the inputs to the shift register group 40 as an output of the post-processing circuit 30.

RO unit outputs are added up and entropy is accumulated in the FFs 31 according to self-feedback by a loop of the FFs 31 and the EXORs 32. Outputs of the respective EXORs 32 are added up by the EXOR 33. By adding up entropy of the RO unit outputs of the respective RO units 20 by addition by the EXOR 33, it is possible to output data obtained by increasing the entropy to the shift register group 40. In other words, even when entropy of the FF 23 outputs is relatively low, it is possible to obtain high-entropy data with the post-processing circuit 30.

Note that, in the feedback loop of the FFs 31 and the EXORs 32, for example, the RO unit outputs are repeatedly added up, for example, four times. In this case, since 1-bit data is output from the RO units 20 in one clock of the system clock CK, 1-bit data is output from the loop of the FFs 31 and the EXORs 32 once in four clocks in the system clock CK. The 1-bit data is output to the shift register group 40 via the EXOR 33.

In the present embodiment, random number generation is divided as explained below. For example, it is assumed that the random number generation is divided into four to generate four divided random numbers. The shift register group 40 includes shift registers 41_0, 41_1, 41_2, and 41_3 in four stages (hereinafter, these shift registers are representatively referred to as shift registers 41) corresponding to the four divided random numbers. Note that the number of bits of the random number and the number of the divided random numbers are not limited to four. An appropriate number can be set.

The respective shift registers 41 have the same configuration and include FFs with enable 42 in m stages (for example, 256 stages). An output of the EXOR 33 is input to the FFs with enable 42 in the first stage of the shift registers 41. The FFs with enable 42 are permitted to capture data at input ends by enable signals SHIFTENy_p3 (y is 0 to 3) and output the data at the input ends from output ends in synchronization with the system clock CK. The respective FFs with enable 42 output the outputs to the input ends of the FFs with enable 42 in the next stage. The outputs of the FFs with enable 42 in the first stage to the last stage are respective bit values of an output (a random number output) of the random number generation circuit 1.

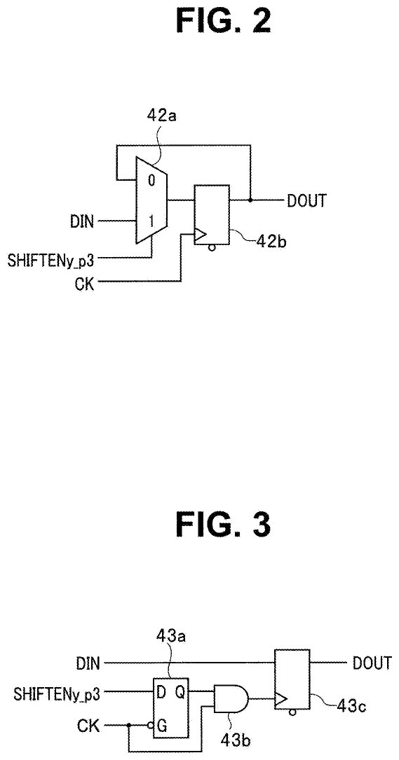

FIGS. 2 and 3 are circuit diagrams showing examples of specific configurations of the FFs with enable 42 shown in FIG. 1. In the example shown in FIG. 2, each of the FFs with enable 42 is configured by a selector 42a and an FF 42b. In the example shown in FIG. 3, each of the FFs with enable 42 is configured by a D latch 43a, an AND circuit 43b, and an FF 43c.

In FIG. 2, in the selector 42a, an input signal DIN to the FF with enable 42 is given to an input end (1) and an output of the FF 42b is given to an input end (0). The selector 42a selects the input signal DIN or an output of the FF 42b and outputs the input signal DIN or the output to the FF 42b according to the enable signal SHIFTENy_p3. When the input end (1) of the selector 42a is selected by the enable signal SHIFTENy_p3, the FF with enable 42 functions as a normal FF. When the input end (0) of the selector 42a is selected by the enable signal SHIFTENy_p3, the FF with enable 42 keeps the output.

1-bit data is output from the post-processing circuit 30, for example, once in four clocks of the system clock CK. The enable signal SHIFTENy_p3 causes the selector 42a to capture an output of the post-processing circuit 30 at timing-corresponding to the output of the post-processing circuit 30. Consequently, an output of the post-processing circuit 30 at every four clocks of the system clock CK is sequentially input to the respective shift registers 41 and transferred to the respective FFs with enable 42. In this way, for example, a 256-bit output is obtained from the shift register 41 in one of 256 stages in 1024 clocks of the system clock CK. By sequentially switching, with the shift registers 41_0, 41_1, 41_2, and 41_3, the shift register 41 that captures the output from the post-processing circuit 30, a random number output of 256×4=1024 bits can be obtained by the respective shift registers 41.

In FIG. 3, a gated clock module is configured by the D latch 43a and the AND circuit 43b. The gated clock module captures the enable signal SHIFTENy_p3 at timing when the system clock CK is “0” and, when the captured enable signal is “1”, gives the system clock CK to the FF 43c with the AND circuit 43b at timing when the system clock CK is “1” next. Consequently, the FF 43c outputs the input signal DIN with the system clock CK in a period designated by the enable signal SHIFTENy_p3. In this way, in the circuit shown in FIG. 3, the FF with enable 42 same as the FF with enable 42 shown in FIG. 2 can be configured.

In the present embodiment, a periodicity detection circuit 25 and a randomness test circuit 26 are provided in each of the RO units 20. As explained above, when the clock period of the system clock CK is nearly in the multiple relation, a fixed value tends to last as an RO unit output and entropy is a small value. The periodicity detection circuit 25 detects periodicity of the RO unit output. The control circuit 10 performs control for changing an oscillation period of an RO 21 based on a detection result.

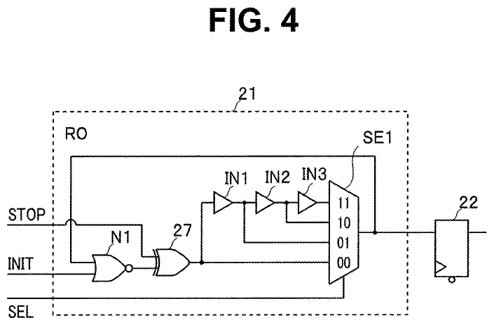

FIG. 4 is a circuit diagram showing an example of a specific configuration of an oscillation frequency variable RO 21.

In FIG. 4, the RO 21 is configured by a NOR circuit N1, an EXOR 27, delay elements IN1, IN2, and IN3, and a selector SE1. In the selector SE1. an output of the EXOR 27 is input to a terminal (00), an output of the delay element IN1 is input to a terminal (01), an output of the delay element IN2 is input to a terminal (10), and an output of the delay element IN3 is input to a terminal (11). The selector SE1 selects and outputs the input to the terminal (00), the terminal (01), the terminal (10), or the terminal (11) according to, for example, (00), (01), (10), or (11) of a 2-bit selection signal SEL[1:0] received from the control circuit 10. The output of the selector SE1 is supplied to one input end of the NOR circuit N1 and supplied to the FF 22 as an output of the RO 21. A signal INIT from the control circuit 10 is input to the other input end of the NOR circuit N1. In the EXOR 27, an output of the NOR circuit N1 is input to one input end and a signal STOP from the control circuit 10 is input to the other input end.

The NOR circuit N1 functions as an inverter when the signal INIT is “0”. An output of the NOR circuit N1 is fixed to “0” when the signal INIT is “1”. The EXOR 27 directly outputs the input when the signal STOP is “0” and functions as an inverter when the signal STOP is “1”.

It is assumed that the signal NIT is “0” and the signal STOP is “0”. In this case, the EXOR 27 directly outputs the output of the NOR circuit N1. When it is assumed that the selector SE1 selects the terminal (00), the output of the NOR circuit N1 is supplied to one input end of the NOR circuit NI via the EXOR 27 and the selector SE1. The RO 21 is configured by an inverter in one stage and oscillates at a specific period. The oscillation period depends on, besides an operating temperature and a voltage, a manufacturing process for a circuit, a driving ability of a circuit in use, the width and the length of a wire used for connection of the circuit, manufacturing variation, and the like. Note that, when the signal STOP is “1”, since the EXOR 27 functions as the inverter, the RO 21 is configured by the inverters in two stages and stops the oscillation. When the signal INIT is “1”, the NOR circuit N1 outputs a fixed value and the RO 21 stops the oscillation.

In other words, the signal STOP stops the oscillation when the signal STOP is “1” and controls the oscillation when the signal STOP is “0”. The signal INIT controls initialization and a stop of the RO oscillation output when the signal INIT is “1”. The signal INIT is “0” at a normal operation time.

When the selector SE1 selects the terminal (01), a delay element in one stage is inserted into a loop of the NOR circuit N1, the EXOR 27, and the selector SE1. The oscillation period of the RO 21 is long. When the selector SE1 selects the terminal (10), delay elements in two stages are inserted into the loop of the NOR circuit N1, the EXOR 27, and the selector SE1. The oscillation period of the RO 21 is longer. Further, when the selector SE1 selects the terminal (11), delay elements in three stages are inserted into the loop of the NOR circuit N1, the EXOR 27, and the selector SE1. The oscillation period of the RO 21 is the longest.

For example, it is assumed that a period of the system clock CK (hereinafter referred to as system clock period) is 120 ns and an RO oscillation period in the case in which a selection signal SEL[1:0]=(00) is given to the selector SE1 is 10 ns. When the selection signal SEL is changed by one stage and the number of delay elements in the loop of the NOR circuit N1, the EXOR 27, and the selector SE1 is increased by one, the RO oscillation period is longer by 2 ns. In other words, in this case the RO oscillation period is 12 ns when a selection signal SEL[1:0]=(01) is given to the selector SE1, the RO oscillation period is 14 ns when a selection signal SEL[1:0]=(10) is given to the selector SE1, and the RO oscillation period is 16 ns when a selection signal SEL[1:0]=(11) is given to the selector SE1.

In other words, in the case of the selection signal SEL[1:0]=(00), (01), the system clock period and the RO oscillation period are in a multiple relation. However, in the case of the selection signal SEL[1:0]=(10), (11), the system clock period and the RO oscillation period are not in the multiple relation. In other words, by changing the selection signal SEL, it is possible to prevent the system clock period and the RO oscillation period from being in the multiple relation.

Note that, in FIG. 4, an example is shown in which the RO 21 is capable of generating four periods as the RO oscillation period. However, periods that the RO 21 is capable of generating are not limited to the four periods. The RO 21 may be configured to be capable of generating an appropriate number of RO oscillation periods.

### Periodicity Detection Circuit/Randomness Test Circuit

The periodicity detection circuit 25 carries out, about an RO unit output, for example, periodicity detection for determining the following two conditions (a1) and (b1). When one of the conditions (a1) and (b1) is satisfied, the periodicity detection circuit 25 outputs a warning (Warning) to the control circuit 10.

(a1) 1 bit of the same logic continuously lasts ten times, and (b1) 3 bits of the same logic or 4 bits of the same logic continuously last for twenty-four clocks

When the warning is output from the periodicity detection circuit 25, the control circuit 10 changes the oscillation period of the RO 21. Consequently, the warning sometimes can be solved.

The randomness test circuit 26 carries out, about an RO unit output, for example, a randomness test for determining the following three conditions (a2) to (c2). When any one of (a2) to (c2) is satisfied, the randomness test circuit 26 outputs an error (Error) to the control circuit 10.

(a2) 1 bit of the same logic continuously lasts twenty-one times, (b2) the same value as a leading bit appears 589 times or more or 435 times or less in 1024 bits, and (c2) 10 bits, 12 bits, 14 bits, and 16 bits of the same logic continuously last for 152 clocks.

The control circuit 10 controls the respective units to generate a divided random number obtained by dividing a random number. The randomness test circuit 26 carries out a randomness test about an RO unit output on which the divided random number is based. When an error is detected by the randomness test about the RO unit output, on which the divided random number is based, carried out by the randomness test circuit 26, the control circuit 10 regenerates the divided random number for which the error is detected.

A jitter that occurs in the ROs 21 of the RO units 20 (fluctuation of the RO oscillation period or fluctuation of timings of a rising edge and a falling edge of the RO oscillation output) and a metastable that occurs in the FFs 22 are sources of occurrence of entropy. However, the RO oscillation period changes because of heat generation at an RO oscillation time or the like. When a change amount of the RO oscillation period is large, the RO oscillation period and the clock period of the system clock CK are in a multiple relation in more opportunities. When the RO oscillation period and the clock period of the system clock CK are nearly in the multiple relation, a fixed value lasts as outputs of the FFs 23, entropy is less easily obtained from the FFs 23, and an error tends to occur in the randomness test circuit 26. In the present embodiment, the random number generation is divided to reduce a randomness test period to reduce the change amount of the RO oscillation period change due to the influence of the heat generation or the like and prevent an error from easily occurring in the randomness test. Even if an error occurs, a divided random number for which the error occurs is regenerated to obtain a high-entropy random number.

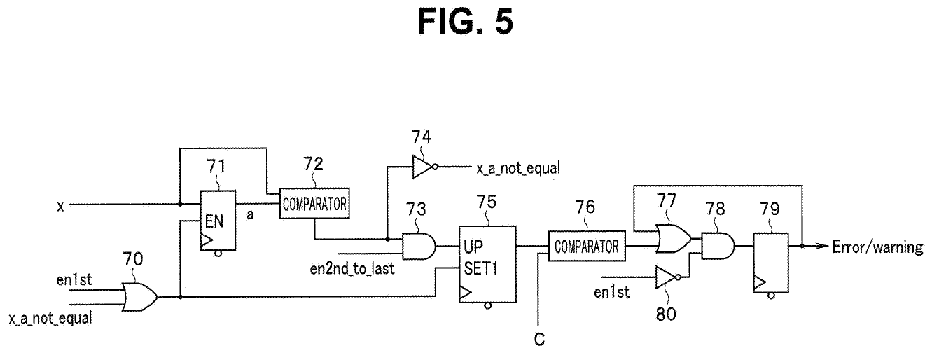

FIG. 5 is a circuit diagram showing an example of circuit configurations of the periodicity detection circuit 25 and the randomness test circuit 26 that enable the periodicity detection and the randomness test under the conditions of (a1) or (a2) described above (1 bit of the same logic continuously lasts C times).

In FIG. 5, “x” represents an RO unit output, en1st represents a signal that becomes “1” only for one clock at a periodicity detection/randomness test start time, and en2nd_to_last represents a signal that becomes “1” from the next clock after the periodicity detection/randomness test start until the periodicity detection/randomness test end. In FIG. 5, “a” represents a value obtained by capturing x at EN=“1” (en1st=“1” or x_a_not_equal=“1”) and x_a_not_equal represents a signal that becomes “1” when “x” and “a” are different.

The signal en1st becomes “1” at the periodicity detection/randomness test start time, whereby, according to an output of an OR circuit 70, input “x” is captured in an FF 71 and output to a comparator 72 as “a”. The comparator 72 compares “x” and “a” and outputs a comparison result about whether “x” and “a” coincide to an AND circuit 73. The signal en2nd_to_last is also input to the AND circuit 73. In the case of x=a, “1” is output from the AND circuit 73 at every system clock CK. When “1” is input to UP, a synchronization counter 75 adds 1 to a retained value and outputs an addition result to a comparator 76.

The output of the comparator 72 is given to an inverter 74 as well. A logical value of “x” sequentially input to the inverter 74 changes, whereby the inverter 74 outputs x_a_not_equal that becomes “1”. The FF 71 captures “x” and outputs “a” to the comparator 72 according to “1” of x_a_not_equal. When x_a_not_equal, which is “1”, is input to SET1, the synchronization counter 75 initializes the retained value to 1. In this way, a count value of the synchronization counter 75 increases until the logic of x is inverted.

A setting value C is given to the comparator 76. When the count value of the synchronization counter 75, that is, a number, the same logic of which continues, reaches a setting value, the comparator 76 outputs “1”. For example, the setting value C is 10 in the periodicity detection circuit 25 and is 21 in the randomness test circuit 26.

The output “1” of the comparator 76 is given to one input end of an AND circuit 78 via an OR circuit 77. An inverted signal of en1st is input to the other input end of the AND circuit 78 via an inverter 80. After the periodicity detection/randomness test starts, the AND circuit 78 outputs, to an FF 79, the output “1” given from the OR circuit 77. The FF 79 outputs the output “1” output from the AND circuit 78 as an error (Error) or a warning at timing of a rising edge of the system clock CK. Note that the output of the FF 79 is retained until en1st becomes “1”. In other words, the output of the FF 79 indicates a warning or an error (Error) output under the condition (a1) or (a2) described above.

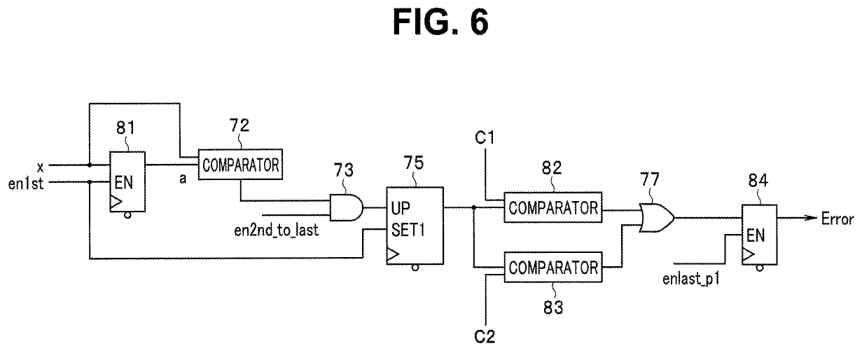

FIG. 6 is a circuit diagram showing an example of a circuit configuration of the randomness test circuit 26 that enables the randomness test under the condition (b2) described above. In FIG. 6, the same components and the same signals as the components and the signals shown in FIG. 5 are denoted by the same reference numerals and signs and explanation of the components and the signals is omitted.

In FIG. 6, enlast_p1 represents a signal that becomes “1” only for one clock after a periodicity detection/randomness test end. The signal en1st becomes “1” at the periodicity detection/randomness test start time, whereby the input “x” is captured in the FF 71 and output to the comparator 72 as “a” (a value of a leading bit). The comparator 72 compares “a” (the value of the leading bit) and the input “x” and, when “x” has the same logic as a logic of the leading bit, outputs “1” to the synchronization counter 75 via the AND circuit 73.

When “1” is input to the UP, the synchronization counter 75 adds 1 to the retained value and outputs an addition result to the comparator 76. When en1st of “1” is input to the SET1, the synchronization counter 75 initializes the retained value to 1. In this way, the count value of the synchronization counter 75 indicates the number of bits having the same logical value as a logical value of the leading bit at the periodicity detection/randomness test start time.

The output of the synchronization counter 75 is given to comparators 82 and 83. The comparator 82 compares the count value of the synchronization counter 75 and a setting value C1 and, when the count value is equal to or larger than the setting value C1, outputs “1” to the OR circuit 77, The comparator 83 compares the count value of the synchronization counter 75 and a setting value C2 and, when the count value is equal to or smaller than the setting value C2, outputs “1” to the OR circuit 77. When at least one of the two inputs is “1”, the OR circuit 77 outputs “1” to an FF 84. The setting value C1 is set to 589 and the setting value C2 is set to 435. The FF 84 outputs the output “1” output from the OR circuit 77 as an error (Error) at timing of the rising edge of the system clock CK in a period in which the enlast_p1 is “1”. In other words, the output of the FF 84 indicates an error (Error) output under the condition (b2) described above.

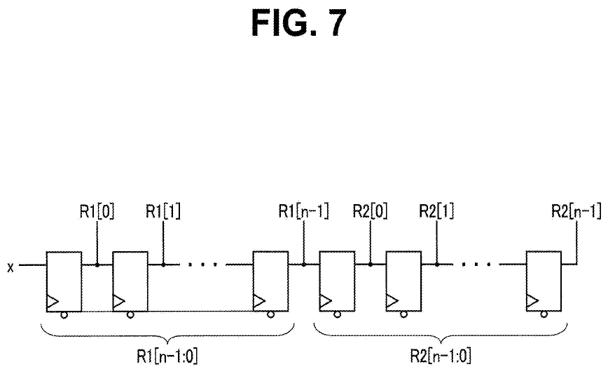

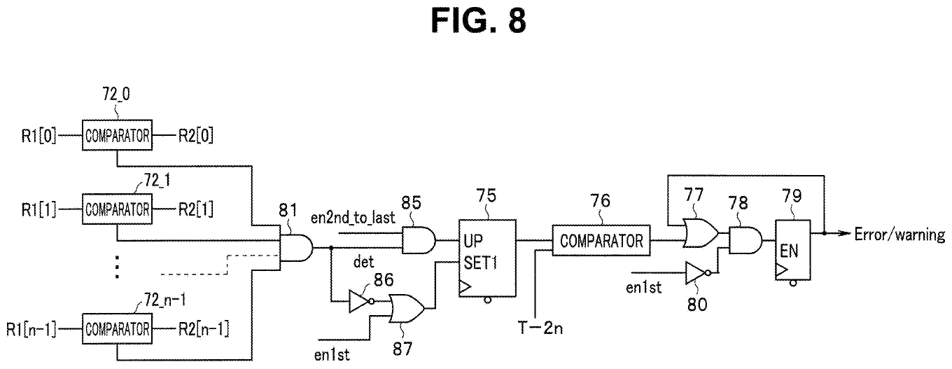

FIGS. 7 and 8 are circuit diagrams showing examples of circuit configurations of the periodicity detection circuit 25 and the randomness test circuit 26 that enable periodicity detection and a randomness test under the condition (b1) or (c2) (n bits of the same logic continuously last for T clocks). In FIGS. 7 and 8, the same components and the same signals as the components and the signals shown in FIG. 5 are denoted by the same reference numerals and signs and explanation of the components and the signals is omitted. Circuits of the periodicity detection circuit 25 and the randomness test circuit 26 include circuits shown in FIGS. 7 and 8.

FIG. 7 shows a shift register. The shift register shown in FIG. 7 includes cascade-connected 2 n FFs. The FFs output inputs to FFs in the next stage. The outputs of the respective FFs are R1[X] and R2[X] (X is 0 to n-1). An RO unit output x is input to the FF in the first stage. In FIG. 7, n FFs from the first stage sequentially shift the RO unit output by n system clocks CK and n FFs from an n-th stage sequentially shift an output R1[n-1] in an n-1-th stage by n system clocks CK. Therefore, R1[X] and R2[X] indicate RO unit outputs deviating by n bits.

FIG. 8 includes a plurality of comparators 72_0, 72_1, . . . , and 72_n (hereinafter, these comparators are representatively referred to as comparators 72). R1[0] and R2[0] are input to the comparator 72_0. R1[1] and R1[2] are input to the comparator 72_1. Similarly, R1[X] and R2[X] are input to the comparators 72. When logics of the two inputs coincide, the respective comparators 72 output “1” to an AND circuit 81. The AND circuit 81 outputs “1” when outputs of all the comparators 72 are “1”. In other words, the AND circuit 81 outputs “1” when each of n bits of continuous RO unit output has the same logic and n bits of continuous RO unit outputs have the same logic. In other words, “1” of the output of the AND circuit 81 indicates a state in which the n bits of the same logic continue.

The output of the AND circuit 81 is given to an AND circuit 85 and an inverter 86 as a det signal. After en2nd_to_last becomes “1”, the AND circuit 85 gives the output of the AND circuit 81 to the synchronization counter 75. The inverter 86 inverts the output of the AND circuit 81 and outputs the output to an OR circuit 87. The OR circuit 87 outputs an OR of the signal en1st that becomes “1” only for one clock at the periodicity detection/randomness test start time and the output of the inverter 86 to the SET1 terminal of the AND circuit 78. Consequently, after the periodicity detection/randomness test starts, the synchronization counter 75 is initialized by the output “1” of the AND circuit 81 and counts up “1” of the AND circuit 85.

In this way, the synchronization counter 75 outputs a count value indicating for how many clocks the n bits of the same logic of the RO unit output continuously last. The output of the synchronization counter 75 is supplied to the comparator 76, A setting value T-2 n is given to the comparator 76. When the count value of the synchronization counter 75, that is, the number of clocks for which the n bits of the same logic continue reaches a setting value, the comparator 76 outputs “1”. The output of the comparator 76 is output from the FF 79 via the OR circuit 77 and the AND circuit 78. In other words, a warning or an error (Error) under the condition (b1) or (b3) described above is output from the FF 79.

Note that the respective units only have to be configured with n=3 and T=24 when it is detected that 3 bits of the same logic continuously last for twenty-four clocks, n=4 and T=24 when it is detected that 4 bits of the same logic continuously last for twenty-four clocks. n=10 and T=152 when it is detected that 10 bits of the same logic continuously last for 152 clocks, n=12 and T=152 when it is detected that 12 bits of the same logic continuously last for 152 clocks, n=14 and T=152 when it is detected that 14 bits of the same logic continuously last for 152 clocks, and n=16 and T=152 when it is detected that 16 bits of the same logic continuously last for 152 clocks.

When all of the periodicity detections and the randomness tests are carried out, simply, six ways of configuration only have to be implemented. However, the shift register can be shared if there is a configuration for n=16 (thirty-two FFs). The synchronization counter 75 can also be shared by prioritizing a det signal that becomes 1 first.

At a random number generation start time, first, the control circuit 10 causes the selector 24 to select the terminal (0). Consequently, the periodicity detection by the periodicity detection circuit 25 is carried out about an RO unit output based on an output of the RO 21a. When a warning occurs from the periodicity detection circuit 25, the control circuit 10 increments a value of SEL[1:0] by one. When four times of warnings occur in the periodicity detection, the control circuit 10 sets the value of SEL[1:0] to “0” and causes the selector 24 to select the terminal (1) according to a selection signal Select. Consequently, thereafter, the periodicity detection by the periodicity detection circuit 25 is carried out about an RO unit output based on an output of the RO 21b. When the selection signal Select is set to SEL[2], the control circuit 10 performs an operation for incrementing a value of SEL[2:0] by one according to warning occurrence.

When an error occurs from the RO unit 20, the control circuit 10 causes the retry counter 50 to count the number of times of errors. The retry counter 50 counts the number of times of errors and outputs a count result to the comparator 60. When the count result of the retry counter 50 exceeds a predetermined threshold, the comparator 60 outputs, to the not-shown higher system such as the host apparatus, an error output (an error notification) indicating that an error has occurred in the random number generation.

### Action

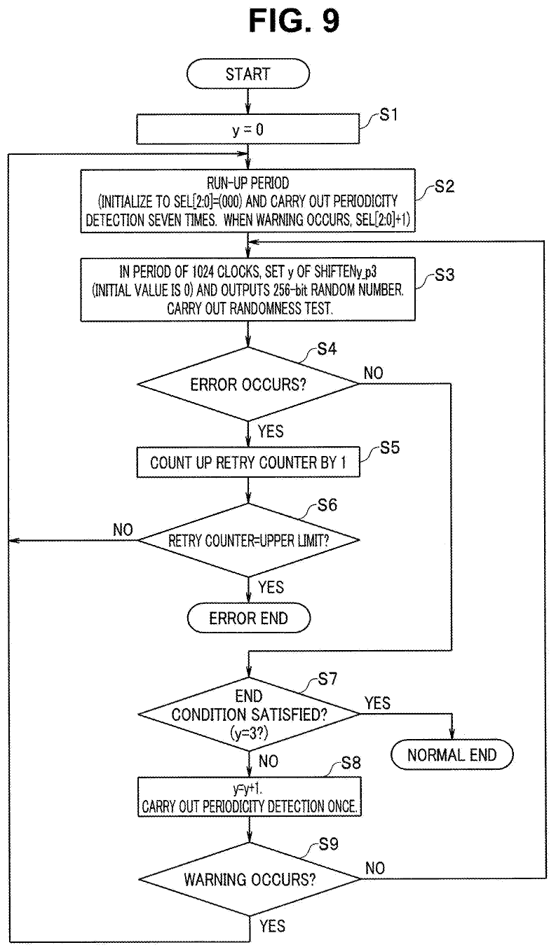

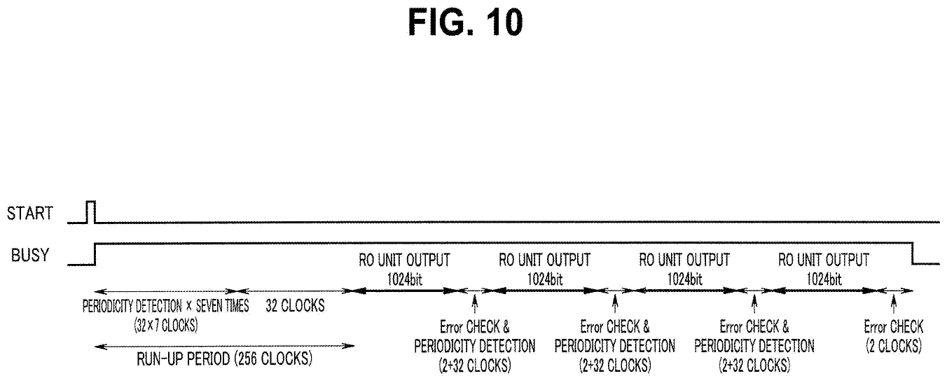

Subsequently, an operation in the embodiment configured as explained above is explained with reference to FIGS. 9 to 15. FIG. 9 is a flowchart for explaining the operation in the present embodiment. FIG. 10 is a timing chart showing operation timing in the present embodiment.

In the present embodiment, an example is explained in which a 1024-bit random number output is divided into four divided random numbers each having 256 bits to generate the divided random numbers. Since the post-processing circuit 30 outputs 1 bit in four clocks, one divided random number is generated by outputting a 1024-bit RO unit output from the RO unit 20.

### Overview

FIG. 10 shows operation timing until a 1024-bit random number output is obtained. Note that an example shown in FIG. 10 indicates a case in which it is determined as a result of a randomness test that an error has not occurred. In FIG. 10, timings of respective operations are indicated by periods of arrows in association with a start signal (START) for instructing a start of random number generation supplied from the not-shown higher system such as the host apparatus and a busy signal (BUSY) output from the control circuit 10.

The random number generation is started by a pulse of the start signal. First, in a run-up period of 256 clocks (hereinafter, a clock indicates the system clock CK), seven times of the periodicity detection are carried out. When the run-up period ends, a 256-bit divided random number is generated and a randomness test is carried out using a 1024-bit RO unit output that is output in a period of 1024 clocks. In the next thirty-four clocks, an error check of the randomness test, periodicity detection, and the like are performed. Thereafter, the generation of a divided random number, the error check, and the like are repeated three times and a 1024-bit random number output is obtained.

### Run-Up Period

In FIG. 9, when the pulse of the start signal is input, first, the control circuit 10 sets y of the enable signal SHIFTENy_p3 for controlling the shift register group 40 to y=0 (S1). Subsequently, the control circuit 10 carries out the run-up period (S2).

### Periodicity Detection

In order to obtain a high-entropy random number output, it is necessary to prevent a system clock period and an RO oscillation period from being in a multiple relation. Therefore, a 256-clock run-up period is provided before the random number generation to adjust the RO oscillation period. In the example shown in FIG. 4, the ROs 21a and 21b are respectively capable of setting an oscillation period to four periods. Therefore, by switching the RO oscillation period as many as seven times, it is possible to perform a periodicity test for an RO unit output based on an RO oscillation output that can be generated by the RO 21. A 3-bit selection signal SEL[2:0] is used as a selection signal SEL used for a change of the RO oscillation period, a lower 2-bit selection signal SEL[1:0] is used for a period change of the RO 21, and a higher 1-bit selection signal SEL[2] is used for switching of the selector 24.

More specifically, the control circuit 10 sequentially switches the selection signal SEL[1:0] for the RO 21a from (00) to (01), (10), and (11) and sequentially switches the selection signal SEL[1:0] for the RO 21b from (00) to (01), (10), and (11). Note that, when the last selection signal SEL[1:0]=(11) for the RO 21b is set, since there is no more period to be switched, an RO oscillation output of an RO oscillation period based on the selection signal SEL[1:0]=(11) is used for the following generation of divided random numbers.

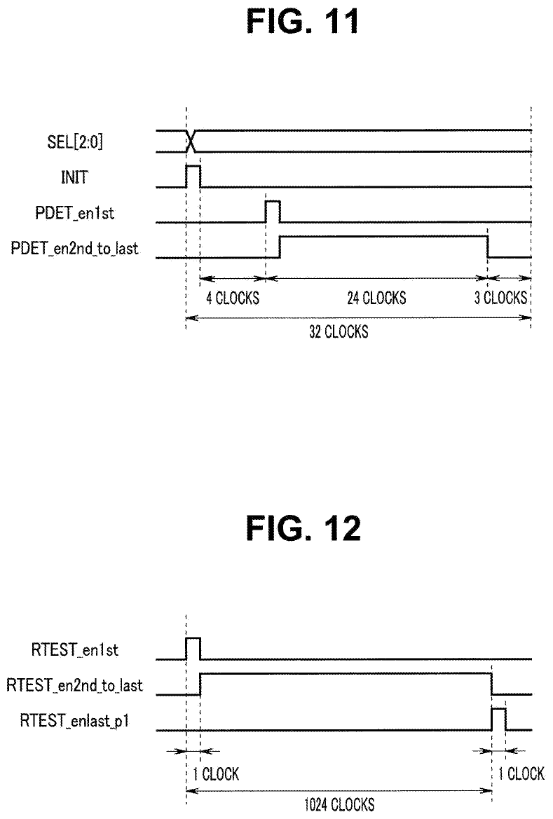

FIG. 11 shows a timing chart at a periodicity detection time. FIG. 11 shows a selection signal SEL[2:0], a signal INIT, a signal PDET_en1st, and a signal PDET_en2nd_to_last. Note that, in FIG. 11, the signals en1st and en2nd_to_last shown in FIGS. 5 and 8 supplied to the periodicity detection circuit 25 are respectively shown as the signal PDET_en1st and the signal PDET_en2nd_to_last.

The control circuit 10 changes the signal INIT from “0” to “1” and initializes an RO oscillation output according to the input of the pulse of the start signal and, thereafter, resets the signal INIT to “0”. The control circuit 10 sets first four clocks after the initialization as a run-up period, and stays on standby. Subsequently, the control circuit 10 sets en1st indicating the periodicity detection start to “1” only for one clock and, thereafter, sets the signal en2nd_to_last to “1” from the next clock of the periodicity detection start to the periodicity detection end. The periodicity detection circuit 25 is input with these signals and carries out the periodicity detection. In the example shown in FIG. 11, the periodicity detection circuit 25 performs the periodicity detection in twenty-four clocks and performs determination about whether conditions are satisfied and determination result notification to the control circuit 10 in the next three clocks. In this way, the periodicity detection circuit 25 performs the periodicity detection once in thirty-two clocks.

When a warning is supplied from the periodicity detection circuit 25 to the control circuit 10 as a result of the periodicity detection, the control circuit 10 increments the selection signal SEL[2:0] by one. For example, a selection signal SEL[2:0] is (000) immediately after the pulse input of the start signal. The selection signal SEL[2:0] changes to (001), (010), (011), . . . every time a warning occurs. In this way, when the warning occurs, the RO oscillation period of the RO 21 is switched. Note that, for example, immediately after the pulse input of the start signal, a selection signal Select (SEL[2]=(0)) is supplied to the selector 24 and an FF 23 output from the RO 21a is selected. However, according to fourth occurrence of a warning, the control circuit 10 changes the selection signal Select [2] to the selection signal SEL[2]=(1) and selects an FF 23 output from the RO 21b. Note that, in this case, the selection signal Select [2] is kept at (1) until the random number generation ends.

The periodicity detection is carried out seven times irrespective of presence or absence of a warning. When the seven times of the periodicity detection end, the control circuit 10 shifts to random number generation and a randomness test after a standby period of thirty-two clocks (S3).

### Divided Random Number Generation and Randomness Test

FIG. 12 shows a timing chart at a randomness test time. FIG. 12 shows a signal RTEST_en1st and signals RTEST_en2nd_to_last and RTEST_enlast_p1. Note that, in FIG. 12, the signal en1st and the signals en2nd_to_last and enlast_p1 shown in FIGS. 5, 6, and 8 supplied to the periodicity detection circuit 25 are respectively shown as the signal RTEST_en1st and the signals RTEST_en2nd_to_last and RTEST_enlast_p1.

At a start time of a period of the divided random number generation and the randomness test, first, the control circuit 10 sets y of the enable signal SHIFTENy_p3 for controlling the shift register group 40 to y=0. An RO unit output is output to the post-processing circuit 30 and the randomness test circuit 26 at every one clock. The FFs 31 and the EXORs 32 of the post-processing circuit 30 add up four clock period RO unit outputs and output an addition result to the EXOR 33. The EXOR 33 adds up and outputs the outputs of all the EXORs 32. The output from the EXOR 33 is captured in the shift register group 40 as 1-bit data once in four clocks. Therefore, a 256-bit divided random number is generated by a 1024-bit RO unit output. The data output from the EXOR 33 is stored in the shift register 41_0 first as a divided random number.

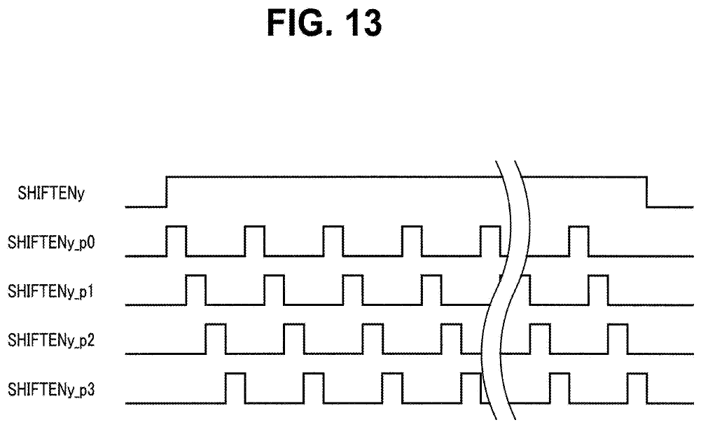

FIG. 13 is a timing chart for explaining the enable signal SHIFTENy_p3 supplied to the shift register group 40. The control circuit 10 generates the enable signal SHIFTENy_p3 in a period in which a signal SHIFTENy is “1”. The control circuit 10 generates SHIFTENy_p0 once in four clocks at the system clock CK from a signal SHIFTENy=1. Further, the control circuit 10 delays SHIFTENy_p0 clock by clock at the system clock CK, generates SHIFTENy_p1, SHIFTENy_p2, and SHIFTENy_p3, and supplies SHIFTENy_p3 generated once in four clocks to the shift register group 40. As explained above, the respective FFs with enable 42 of the shift registers 41_0 to 41_4 capture and output input data respectively according to “1” of enable signals SHIFTEN0_p3, SHIFTEN1_p3, SHIFTEN2_p3, and SHIFTEN3_p3.

At the start time of the period of the divided random number generation and the randomness test, the data output from the EXOR 33 is sequentially transferred to the respective FFs with enable 42 once in four clocks by the enable signal SHIFTEN0_p3. In this way, a 256-bit divided random number is retained in the shift register 41_0.

At the start time of the period of the divided random number generation and the randomness test, as shown in FIG. 12, the control circuit 10 sets en1st indicating a randomness test start to “1” only for one clock and, thereafter, sets the signal en2nd_to_last to “1” from the next clock of the randomness test start to a randomness test end. An RO unit output is input to the randomness test circuit 26 in every one clock. The randomness test circuit 26 is input with the respective signals shown in FIG. 12 and carries out the randomness test.

In other words, the randomness test circuit 26 carries out the randomness test about a 1024-bit RO unit output for generating a divided random number. As shown in FIG. 10, the randomness test circuit 26 checks a result of the randomness test in the next two clocks of the randomness test about the 1024-bit RO unit output (S4). When the result of the randomness test indicates that there is no error (NO determination in S4), the control circuit 10 determines an end condition about whether a random number output of the number of bits requested from the host apparatus or the like is generated (S7). When there is no error in the randomness test and divided random numbers are stored in all of the shift registers 41 of the shift register group 40, that is, in the case of y=3, a 1024-bit random number output is generated and the end condition is satisfied (YES determination in S7). Therefore, the control circuit 10 ends the processing (a normal end).

When there is no error in the randomness test and the end condition is not satisfied (NO determination in S7), in the next S8, the control circuit 10 increments y and, thereafter, carries out the periodicity detection once. In this case, as shown in FIG. 10, the periodicity detection shown in FIG. 11 is carried out once in thirty-two clocks after a two-clock period for an error check. When a warning does not occur in the periodicity detection (NO determination in S9), the control circuit 10 returns the processing to S3, sets the enable signal SHIFTENy_p3 (y=1) to “1” once in four clocks, and transfers a divided random number generated next to the shift register 41_1. Thereafter, according to the same operation, the control circuit 10 transfers divided random numbers to all the shift registers 41 and obtains a 1024-bit random number output. On the other hand, when a warning occurs in the periodicity detection (YES determination in S9), the control circuit 10 shifts to S2, carries out the run-up period, and carries out the next random number generation. Note that RO unit outputs in the two-clock period for the check of the result of the randomness test and the period for the periodicity detection of thirty-two clocks following the two-clock period or the run-up period are not used for the randomness test and the random number output.

On the other hand, when the result of the randomness test indicates that there is an error (YES determination in S4), the randomness test circuit 26 outputs an error to the control circuit 10. In this case, the control circuit 10 instructs the retry counter 50 to count up the retry counter (S5). The comparator 60 determines whether a count value of the retry counter 50 has reached an upper limit (S6). When the count value of the retry counter 50 has not reached the upper limit (NO determination in S6), the control circuit 10 shifts to S2 and carries out the run-up period and further repeats the generation of a divided random number and the randomness test. Note that, in this case, the control circuit 10 discards a divided random number determined as having an error in the last randomness test and uses, for a random number output, a divided random number generated anew. When the count value of the retry counter 50 has reached the upper limit (YES determination in S6), the comparator 60 generates an error output (an error notification) based on an output of the retry counter 50 and ends the random number generation processing. Note that the error output is supplied to the host apparatus or the like.

### Specific Example of an Operation

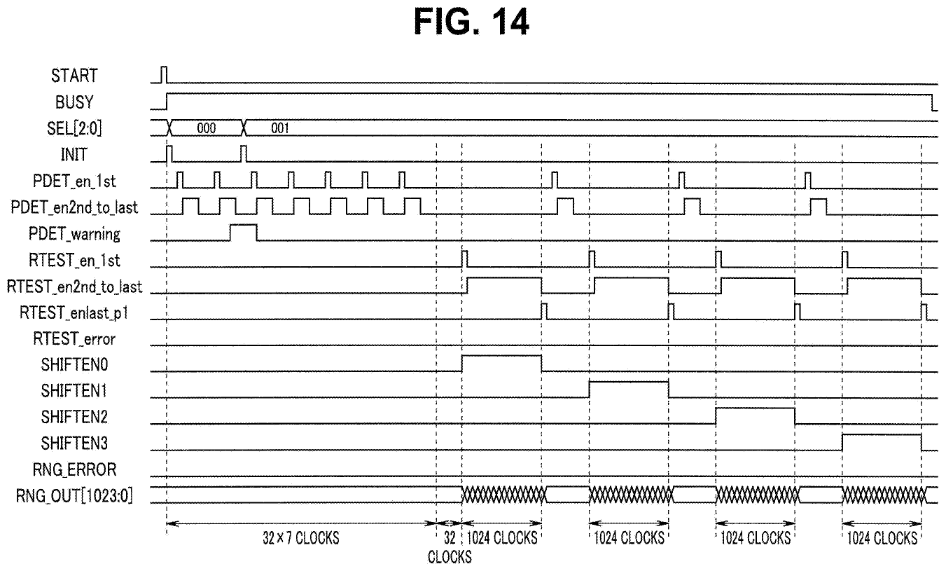

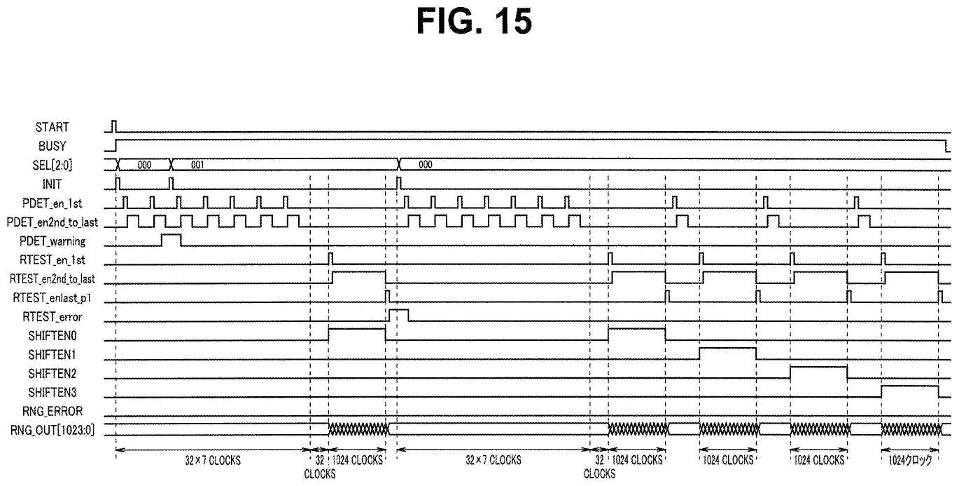

Subsequently, a specific example of an operation is explained with reference to timing charts of FIGS. 14 and 15. FIG. 14 is a timing chart showing random number generation in the case in which a warning occurs in second periodicity detection in the run-up period. FIG. 15 is a timing chart showing random number generation in the case in which a warning occurs in the second periodicity detection in the run-up period and an error is caused by a randomness test for an RO unit output for generating a first divided random number. Note that signal names shown in FIGS. 14 and 15 are the same as the signal names in the above explanation. The enable signal SHIFTENy_p3 is described as enable signal SHIFTENy(y=0 to 3). A warning from the periodicity detection circuit 25 is described as PDET_warning. An error from the randomness test circuit 26 is described as RTEST_error. An error from the comparator 60 in the case in which the count value of the retry counter 50 exceeds an upper limit value is described as RNG_ERROR. A random number output including a divided random number is described as RNG_OUT[1023:0].

In FIG. 14, after a pulse input of a start signal (START), an RO oscillation output is initialized by the signal INIT and an RO oscillation period of the RO 21a is set by the selection signal SEL[2:0]=(000). Periodicity detection is started by PDET_en1st and the periodicity detection is carried out in a period of “1” of PDET_en2nd_to_last. As shown in FIG. 14, seven times of the periodicity detection are carried out in a run-up period of 32×7 clocks irrespective of presence or absence of occurrence of a warning.

In the example shown in FIG. 14, after second periodicity detection, a warning (PDET_warning) occurs from the periodicity detection circuit 25. Consequently, the selection signal SEL[2:0] changes to (001) and the RO oscillation period of the RO 21a is changed. Thereafter, in the run-up period, a warning from the periodicity detection circuit 25 does not occur and an RO oscillation output at an RO oscillation period based on the selection signal SEL[2:0]=(001) is used for random number generation.

After thirty-two clocks from the run-up period, a randomness test is started by RTEST_en1st. Generation of a divided random number and a randomness test for an RO unit output for generating the divided random number are carried out in a period until an end of the randomness test by RTEST enlast_p1 in a period of “1” of RTEST_en2nd_to_last.

In the example shown in FIG. 14, an error does not occur from the randomness test circuit 26. After the divided random number generation and the randomness test, one periodicity detection by PDET_en1st and PDET_en2nd_to_last is executed. Thereafter, the divided random number generation, the randomness test, and the periodicity detection are repeated. Since an error does not occur for the randomness test at a fourth divided random number generation time, in the example shown in FIG. 14, the random number generation ends and the busy signal (BUSY) becomes “0”. In this way, in the example shown in FIG. 14, a 256-bit divided random number is generated four times and a 1024-bit random number output is obtained.

In FIG. 15, an operation in the run-up period is the same as the operation shown in FIG. 14. As in FIG. 14, after thirty-two clocks from the run-up period, a randomness test is started by RTEST_en1st. Generation of a divided random number and a randomness test for an RO unit output for generating the divided random number are carried out in a period until an end of the randomness test by RTEST_enlast_p1 in a period of “1” of RTEST_en2nd_to_last.

In the example shown in FIG. 15, as a result of an error check for the randomness test at the first divided random number generation time. RTEST_error occurs from the randomness test circuit 26. When receiving RTEST_error, the control circuit 10 sets a run-up period again. In other words, as shown in FIG. 15, the control circuit 10 initializes an RO oscillation output with the signal INIT, selects the terminal (0) of the selector 24 with the selection signal SEL[2:0]=(000), and returns the RO oscillation period of the RO 21a to an initial state. The control circuit 10 starts periodicity detection with PDET_en1st and carries out the periodicity detection in the period of “1” of PDET_en2nd_to_last. As shown in FIG. 15, seven times of the periodicity detection are carried out in a run-up period of 32×7 clocks irrespective of presence or absence of occurrence of a warning.

In the example shown in FIG. 15, in a period of seventh periodicity detection, a warning (PDET_warning) does not occur from the periodicity detection circuit 25 and the RO oscillation period of the RO 21a is not changed. Therefore, an RO oscillation output at an RO oscillation period based on the selection signal SEL[2:0]=(000) is used for random number generation.

After thirty-two clocks from the run-up period, a randomness test is started by RTEST_en1st. Generation of a divided random number and a randomness test for an RO unit output for generating the divided random number are carried out in a period until an end of the randomness test by RTEST_enlast_p1 in a period of “1” of RTEST_en2nd_to_last. Note that, in this case, a first divided random number that was an error last time is discarded. Generation of a new first divided random number and a randomness test for a 1024-bit RO unit output for generating the divided random number are performed.

In the example shown in FIG. 15, thereafter, an error does not occur from the randomness test circuit 26. After the divided random number generation and the randomness test, first periodicity detection by PDET_en1st and PDET_en2nd_to_last is executed. Then, the divided random number generation the randomness test, and the periodicity detection are repeated. Since an error does not occur for the randomness test at a fourth divided random number generation time, in the example shown in FIG. 15, the random number generation ends and the busy signal (BUSY) becomes “0”. In this way, in the example shown in FIG. 15 as well, a 256-bit divided random number is generated four times and a 1024-bit random number output is obtained. In the example shown in FIG. 15, since the error occurs in the randomness test at the first divided random number generation time, the divided random number generation is resumed from the first divided random number generation. However, the divided random number generation only has to be resumed about a divided random number in which an error occurs in the randomness test. For example, when an error occurs in the randomness test at a third divided random number generation time, the random number generation only has to be performed from the third divided random number generation again. Note that the count value of the retry counter 50 is counted up every time an error occurs in the randomness test, when the count value reaches the upper limit, RNG_ERROR indicating that an error occurs in the random number generation occurs, and the random number generation ends.

As explained above, in the present embodiment, a random number is divided into a divided random number of a predetermined number of bits to generate the divided random number, the randomness test circuit is provided in the RO unit, and the randomness test is carried out for an RO unit output for generating the divided random number. Since the divided random number is generated in a shorter time than a random number generation time in which the random number is not divided, it is possible to limit a change amount of an RO oscillation period change due to the influence of heat generation or the like. It is possible to reduce occurrence of an error of the randomness test and obtain a random number having a high entropy value. Since the periodicity detection is carried out every time the divided random number is generated, it is possible to perform a setting change to an RO oscillation period at which high entropy is easily obtained. Even when an error of the randomness test occurs, an RO oscillation period for avoiding the error can be set. Therefore when an error of the randomness test accidentally occurs because of an RO oscillation period change due to the influence of heat generation or the like, it is possible to achieve efficiency of the random number generation by not performing an error notification to the higher system until an error count number of the randomness test reaches an upper limit value. When the error count number of the randomness test reaches the upper limit value, a failure can be notified to the higher system. Since two systems for the main oscillation circuit and the backup oscillation circuit are provided as the ROs, there is also an effect that reliability is high against a failure and deterioration.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A random number generation circuit comprising:
a sampling circuit configured to capture an oscillation output of a ring oscillator using a first clock and generate a random number value;
a periodicity detection circuit configured to detect periodicity of an output of the sampling circuit;
a randomness test circuit configured to perform a randomness test for the output of the sampling circuit; and
a control circuit configured to change an oscillation period of the oscillation output based on a detection result of the periodicity detection circuit, divide a random number output based on the random number value into a plurality of divided random numbers to perform random number generation for each of the divided random numbers, and cause the randomness test circuit to execute the randomness test for each generation of the divided random numbers.

2. The random number generation circuit according to claim 1, wherein, when detecting occurrence of an error as a result of executing the randomness test for each generation of the divided random numbers, the control circuit changes the oscillation period based on the detection result of the periodicity detection circuit and, thereafter, discards the divided random numbers set as a target of the error, and generates the divided random numbers anew and causes the randomness test circuit to execute the randomness test anew.

3. The random number generation circuit according to claim 1, wherein, before the randomness test, the control circuit perfonus one or more times of detection of the periodicity and changes the oscillation period based on a detection result.

4. The random number generation circuit according to claim 2, wherein, before the randomness test, the control circuit performs one or more times of detection of the periodicity and changes the oscillation period based on a detection result.

5. The random number generation circuit according to claim 2, wherein, when detecting the occurrence of the error as the result of executing the randomness test for each generation of the divided random numbers, the control circuit counts a number of times of the occurrence of the error and, when a count value reaches an upper limit value, performs control to generate an error notification.

6. A random number generation circuit comprising:
a first ring oscillator;
a second ring oscillator;
a selector configured to select an oscillation output of one of the first ring oscillator and second ring oscillator;
a sampling circuit configured to capture the oscillation output from the selector using a first clock and generate a random number value;
a periodicity detection circuit configured to detect periodicity of an output of the sampling circuit;
a randomness test circuit configured to perform a randomness test for the output of the sampling circuit; and
a control circuit configured to change an oscillation period of the oscillation output based on a detection result of the periodicity detection circuit, divide a random number output based on the random number value into a plurality of divided random numbers to perform random number generation for each of the divided random numbers, and cause the randomness test circuit to execute the randomness test for each generation of the divided random numbers.

7. The random number generation circuit according to claim 6, wherein the control circuit controls the selector based on the detection result of the periodicity detection circuit.
